(19) United States
(12) Patent Application Publication
(10) Pub. No.: US 2023/0369854 A1
(43) Pub. Date: Nov. 16, 2023

(54) METHOD AND APPARATUS FOR CHECKING POWER GRID MEASUREMENT DATA, DEVICE, STORAGEMEDIUM AND PROGRAM PRODUCT

(71) Applicant: CHINA ELECTRIC POWER RESEARCH INSTITUTE, Beijing (CN)

(72) Inventors: Lin XIE, Beijing (CN); Linpeng ZHANG, Beijing 100192 (CN); Lixin LI, Beijing (CN); Hongqiang XU, Beijing (CN); Tianlong QU, Beijing (CN); Ruili YE, Beijing (CN); Zechen WEI, Beijing (CN); Fengbin ZHANG, Beijing (CN); Yan WANG, Beijing (CN); Can CUI, Beijing (CN); Yujia LI, Beijing (CN); Jinsong Li, Beijing (CN); Qiong FENG, Beijing (CN); Miao WANG, Beijing (CN); Xiaolin QI, Beijing (CN); Chengjian QIU, Beijing (CN)

(21) Appl. No.: 18/246,563

(22) PCT Filed: Feb. 7, 2022
(86) PCT No.: PCT/CN2022/075411

§ 371 Date: Mar. 24, 2023

(30) Foreign Application Priority Data
Dec. 4, 2020 (CN) 202011397371.X

(51) Int. Cl. H02J 3/00

(52) U.S. Cl. CPC H02J 3/00125

(57) ABSTRACT

A method and apparatus for checking power grid measurement data, a device, a storage medium and a program product. The method includes: a feature factor of power grid measurement data is extracted; power balance of a set time scale is checked based on the measurement data and the feature factor to obtain a check result; a classification rule base of abnormal problems of measurement data is built based on the check result; and an abnormal problem in target measurement data is checked based on the classification rule base of abnormal problems of measurement data, to obtain a measurement data quality report.

### CROSS-REFERENCE TO RELATED APPLICATION

The present disclosure is filed based upon and claims priority to Chinese patent application No. 202011397371.X, filed on Dec. 4, 2020 and entitled “METHOD AND SYSTEM FOR LONG-TIME SCALE POWER BALANCE CHECK AND BIG DATA ANALYSIS”, the disclosure of which is hereby incorporated by reference in its entirety.

### TECHNICAL FIELD

The present disclosure belongs to the field of computer software and electrical power system automation, and relates to a method, apparatus and device for checking power grid measurement data, a storage medium and a program product.

### BACKGROUND

Power grid dispatching is not only a nerve hub to maintain the coordinated operation of various links of power generation, transmission, distribution and utilization, but also an online platform to implement optimal allocation of energy resources. At present, hierarchical construction is adopted for dispatching the automation system, and dispatching agencies at all levels have built about 1,800 sets of dispatching automation master stations, which are connected to nearly 50,000 sets of plant station power monitoring systems, thus implementing real-time monitoring of more than 35 kV power plant stations and forming a huge industrial Internet of Things. Relying on the long-term operation of the power grid, a wealth of operation data and management data have been formed and accumulated, and these data provide important data sources for the support of big data platform.

The data sources for regulating the big data platform are increasing rapidly, the data types are becoming more and more diverse, the data scale and processing pressure are increasing rapidly, and the requirements for improving the ability of data collection, gathering, control, calculation and application are constantly improving. The quality of data will directly affect the power grid operation state evaluation and power data value mining ability. In an actual power grid dispatching control system, many reasons such as a collection device fault, a collection error, an Identity Document (ID) mapping error, network congestion, data forwarding delay, a model maintenance error will affect the quality of measurement data reported by power dispatching centers in various regions. Active power balance of a power plant station, a line, a transformer and other objects in the power system may directly reflect the operation status of the power grid, which is also an important index to reflect the accuracy of the measurement data, directly performs statistical analysis on the active power data of a power device object, and has a clearer directivity to the problems of data quality. However, at present, a method for checking the accuracy of measurement data only considers the data quality of a single section, and the comprehensive evaluation of long-time scale massive power grid regulation measurement data has not been implemented, which leads to limited types of abnormal data detected and the lack of means to discover hidden problems from historical features of data. Therefore, it is of great significance to study the method for checking accuracy of power grid regulation measurement data based on long-time scale power balance. In a current dispatching system, there are some bad data detection solutions such as using a steady-state/dynamic data collection apparatus to collect measurement data, and calculating bus power imbalance through a measurement value of a section. The identification rules of a corresponding bad data active power model and a reactive power balance detection model are as follows:

|Σᵢ₌₀ⁿ(pᵢ)|<20

|Σᵢ₌₀ⁿ(Qᵢ)|<30

where pᵢ is incoming active power, Qᵢ is incoming reactive power, and n is the number of incoming lines.

According to the above rules, whether steady-state data of the detection model of a corresponding identification body is abnormal or not is judged. If so, Pressure Measuring Unit (PMU) dynamic data corresponding to the above-mentioned steady-state data is acquired, and the PMU dynamic data is brought into the identification rule of a corresponding bad data monitoring model to judge whether the set rule is met. If so, the above-mentioned steady-state data is unreasonable data.

The related art often only considers the data quality of a single section, usually calculates the incoming power of the bus at a certain moment, and fails to perform feature extraction and analysis on long-period operation data and management data, so it is impossible to implement the comprehensive evaluation of the long-time scale massive power grid regulation measurement data. The related art fails to perform analysis and classified detection on the causes of power imbalance in long-period historical data, resulting in limited types of abnormal data detected, and the lack of means to discover hidden problems from the historical features of data. In addition, an existing calculation and detection method fails to make full use of big data analysis technology, and there is no storage and calculation framework based on distributed cluster for data storage and processing, so the analysis and checking speed of TB-level massive measurement data needs to be improved.

### SUMMARY

The present disclosure aims to solve the problems in the above-mentioned related art, and provides a method and apparatus for checking power grid measurement data, a device, a storage medium, and a program product by integrating feature factors such as a time-space relationship, a topological structure and an electrical relationship of massive measurement data. Herein, the method utilizes a method for checking the accuracy of power grid regulation measurement data based on long-time scale power balance to acquire long-period operation data and management data by relying on a big data platform. Based on grid model data, quality features of long-period measurement data and the status of a power device are extracted by a Spark distributed computing engine, a configurable and extensible grid panoramic measurement data rule base is built, rapid diagnosis of power imbalance data is implemented by using a long-time scale power balance algorithm, and multi-dimensional dynamic and interactive display and analysis on a data quality report are performed through the big data visualization analysis technology, which assists in the daily data quality control and inspection work, improves the data quality, and provides high-quality panoramic data support for deep mining of power grid data value.

In order to achieve the above purpose, the present disclosure is implemented by adopting the following technical solution: a first aspect of the present disclosure provides a method for checking power grid measurement data, which may include that a feature factor of power grid measurement data is extracted; power balance of a set time scale is checked based on the measurement data and the feature factor to obtain a check result; a classification rule base of abnormal problems of measurement data is built based on the check result; and an abnormal problem in target measurement data is checked based on the classification rule base of abnormal problems of measurement data, to obtain a measurement data quality report.

A second aspect of the present disclosure provides an apparatus for checking power grid measurement data, which may include: a feature extraction module, configured to extract a feature factor of power grid measurement data; a data check module, configured to check power balance of a set time scale based on the measurement data and the feature factor to obtain a check result; a database building module, configured to build a classification rule base of abnormal problems of measurement data based on the check result; and a data analysis module, configured to check an abnormal problem in target measurement data based on the classification rule base of abnormal problems of measurement data, to obtain a measurement data quality report.

A third aspect of the present disclosure provides an electronic device, including a memory, a processor and a computer program which is stored in the memory and may run on the processor. When executing the computer program, the processor implements the steps of the above method.

A fourth aspect of the present disclosure provides a computer readable storage medium, and a computer program is stored on the computer readable storage medium. When executed by a processor, the computer program implements the steps of the above method.

A fifth aspect of the present disclosure provides a computer program product, including a computer-readable storage medium storing a program code. Instructions included in the program code implement the steps of the above method when run by a processor of a computer device.

Compared with the related art, the present disclosure has the following beneficial effects.

In the present disclosure, power balance of a set time scale is checked based on measurement data and a feature factor to obtain a check result; a classification rule base of abnormal problems of measurement data is built based on the check result; and an abnormal problem in target measurement data is checked based on the classification rule base of abnormal problems of measurement data, to obtain a measurement data quality report. Thus, the embodiments of the present disclosure can quickly judge the abnormal problems and causes of measurement data, improve the data analysis ability, and provide technical support for lean management of deep mining and regulation of data value of the large power grid.

### BRIEF DESCRIPTION OF THE DRAWINGS

In order to more clearly explain the technical solutions of the embodiments of the present disclosure, the drawings used in the embodiments will be briefly introduced below. It is to be understood that the following drawings only illustrate some embodiments of the present disclosure, which therefore should not be regarded as limitations to the scope. For those of ordinary skill in the art, other related drawings may also be obtained in accordance with these drawings without creative efforts.

FIG. 1A is a flowchart of a method for checking power grid measurement data according to an embodiment of the present disclosure.

FIG. 1B is a flowchart of a method for checking power grid measurement data according to an embodiment of the present disclosure.

FIG. 2 is a frame diagram of an apparatus for checking power grid measurement data according to an embodiment of the present disclosure.

FIG. 3 is a frame diagram of an apparatus for checking power grid measurement data according to an embodiment of the present disclosure.

### DETAILED DESCRIPTION

In order to make the purposes, technical solutions and advantages of the embodiments of the present disclosure clearer, the technical solutions in the embodiments of the present disclosure will be clearly and completely described below in combination with the drawings in the embodiments of the present disclosure, and it is apparent that the described embodiments are only a part rather all of embodiments of the present disclosure. Components of the embodiments of the present disclosure generally described and illustrated here in the drawings may be arranged and designed in various different configurations.

Therefore, the following detailed descriptions of the embodiments of the present disclosure provided in the drawings are not intended to limit the scope of the claimed disclosure, but only represent selected embodiments of the present disclosure. All other embodiments obtained by those of ordinary skill in the art based on the embodiments of the present disclosure without creative efforts shall fall within the protection scope of the present disclosure.

It is to be noted that similar numbers and letters indicate similar items in the following drawings, so once a certain item is defined in one drawing, no further definitions and explanations are required for same in the subsequent drawings.

In the descriptions of the embodiments of the present disclosure, it is to be noted that the orientation or location relationships indicated by the terms “upper”, “lower”, “horizontal”, and “inner” are orientation or location relationships shown on the basis of the drawings, or the usual orientation or location relationship of the product when in use, which are only for the convenience of describing the present disclosure and simplifying the descriptions, rather than indicating or implying that the referred apparatuses or elements must have a specific orientation, and be constructed and operated in the specific orientation. Therefore, it cannot be understood as a limitation of the present disclosure. In addition, terms “first” and “second” are only used for describing purposes, and cannot be understood as indicating or implying relative importance.

In addition, if term “horizontal” appears, it does not mean that components are required to be absolutely horizontal, but can be slightly inclined. For example, “horizontal” only means that its direction is more horizontal than “vertical”, which does not mean that the structure must be completely horizontal, but can be slightly inclined.

In the descriptions of the embodiments of the present disclosure, it is also to be noted that, unless otherwise specified and defined, terms “connection”, “fixed connection”, “mounting”, and “assembly” should be generally understood. For example, the term may be fixed connection, or detachable connection, or integral connection, or mechanical connection, or electric connection. The term may be direct connection, or indirect connection through an intermediate, or communication inside two elements. Those of ordinary skill in the art may understand the meanings of the terms in the present disclosure according to an actual situation.

The present disclosure is further elaborated below in combination with the accompanying drawings.

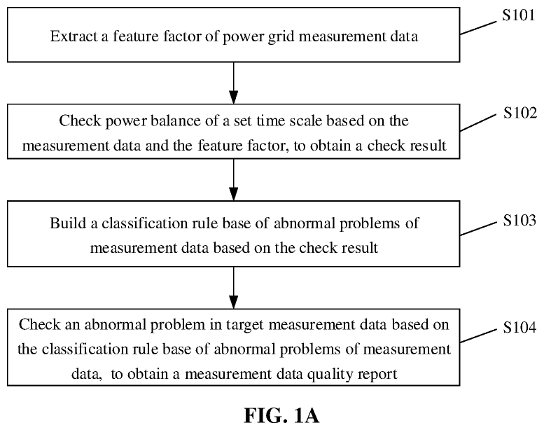

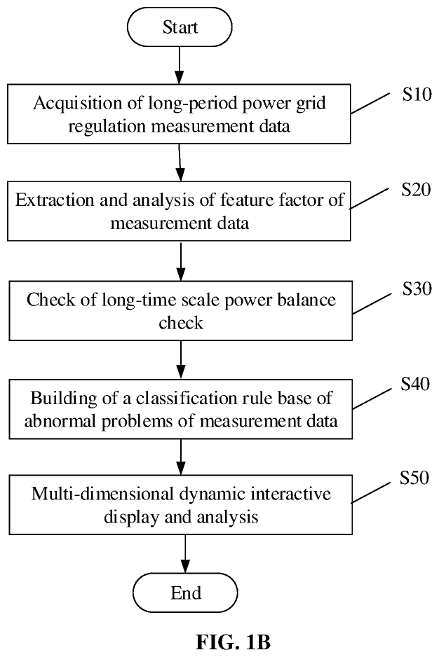

FIG. 1A is a method for checking power grid measurement data according to an embodiment of the present disclosure. The method is executed by a computer device. As shown in FIG. 1A, the method includes the following operations.

At S101, a feature factor of power grid measurement data is extracted.

In some embodiments, massive power grid measurement data is extracted first, and then the feature factor of the measurement data is extracted.

At S102, power balance of a set time scale is checked based on the measurement data and the feature factor, to obtain a check result.

At S103, a classification rule base of abnormal problems of measurement data is built based on the check result.

At S104, based on the classification rule base of abnormal problems of measurement data, an abnormal problem in target measurement data is checked, to obtain a measurement data quality report.

Here, the target measurement data is the measurement data which is selected according to actual needs and requires analysis on the abnormal problem. For example, the measurement data of one week in a plant station is selected as the target measurement data.

In the present disclosure, power balance of a set time scale is checked based on measurement data and a feature factor, to obtain a check result; a classification rule base of abnormal problems of measurement data is built based on the check result; and based on the classification rule base of abnormal problems of measurement data, one or more abnormal problems in target measurement data are checked to generate a measurement data quality report. Thus, the present disclosure can quickly judge the abnormal problems and causes of measurement data, improve the data analysis ability, and provide technical support for lean management of deep mining and regulation of data value of large power grid.

FIG. 1B is a method for checking power grid measurement data according to an embodiment of the present disclosure. Long-period operation data and management data of a power grid are acquired based on a big data platform. By integrating grid model data, feature factors such as a time-space relationship, a topological structure and an electrical relationship of power grid regulation measurement data are extracted. Then, a method for checking the accuracy of measurement active data based on long-time scale power balance is proposed to build a configurable and extensible classification rule base of abnormal problems of measurement data. Finally, multi-dimensional dynamic and interactive display and analysis on a data quality report are performed through big data visualization analysis technology, which implements fast positioning on data abnormal problems and causes, and provides high-quality data support for mining of big power grid data value.

As shown in FIG. 1B, the method includes the following steps.

At S10, long-period power grid regulation measurement data is acquired, massive power grid regulation measurement data, model data and dictionary data are extracted, and a measurement check data set is built by modeling in different dimensions such as power device objects, data sources and time.

In some embodiments, newly added measurement data is acquired every day, for example, all the data of yesterday are acquired today for analysis and check, and the period at this time is set according to the day. In other embodiments, a time scale may also be set as required, for example, data for one week, one month or longer are to be analyzed.

In some embodiments, through a Spark distributed computing engine, massive operation data, management data, model data and dictionary data are extracted from an Hbase column database and a Hive data warehouse at a power grid regulation big data platform, and a measurement check data set is built by modeling in different dimensions such as a power device object, a data source and time.

During implementation, first, the power grid regulation big data platform acquires a data message sent by the cloud through a message bus, takes a power device container, a primary power device and the external environment as data objects, analyzes the message, and stores daily incremental power grid regulation measurement data according to the year and a power dispatching data object dimension table. Then, operation data is extracted from the Hbase column database of the power grid regulation big data platform using the Spark distributed computing engine, and by analyzing Rowkey and business timestamp of the Hbase column database, the newly added daily measurement data is loaded into a cluster memory. Meanwhile, the daily updated management data, model data and dictionary data are synchronized into Redis from the Hive data warehouse as required. Finally, the measurement data, model data and dictionary data are associated and screened to build a multi-dimensional measurement check data set.

In some embodiments, the data is acquired from a source data terminal and stored in a big data platform database, and then set-period measurement data is acquired from the database. As the operation data (including but not limited to measurement data) are all coded information, it is also necessary to associate with the model data and the dictionary data to filter and associate the data, and finally the required operation data, model data and dictionary data are loaded into a memory to prepare data for subsequent calculation and check.

The power grid regulation big data platform stores, based on, a design principle in unified storage of the regulation cloud, relying on component characteristics of the Hbase column database and the Hive data warehouse, the operation data, management data, model data and dictionary data formed and accumulated by long-term operation of the power grid.

The power grid regulation big data platform acquires a data message sent by the cloud through a message bus, takes a power device container, a primary power device, the external environment, etc., as data objects, performs data analysis according to structured design of the power dispatching data object, and stores massive power grid regulation measurement data according to the year and the power grid dispatching data object dimension table.

The data is acquired by analyzing the Rowkey of the Hbase column database and the service timestamp, information such as the newly added daily measurement data and updated model data is loaded into a cluster memory, and a measurement check data set is built for the measurement data in dimensions such as power device object, data source, measurement type, and voltage level, for algorithmic iterative calculating and interactive query.

At S20, feature factors of power grid regulation measurement data such as a time-space relationship, a topological structure and change frequency are extracted and analyzed.

Here, information such as a grid operation data index and a device basic parameter is analyzed according to the measurement check data set based on grid model data, and the feature factors such as the time-space relationship, the topological structure and the electrical relationship of the measurement data are extracted.

Here, the time-space relationship analysis includes analysis of measurement data time series correlation and analysis of a scheduling management relationship between scheduling organization(s) and device(s), an operation and maintenance management relationship between operation and maintenance organization(s) and device(s), and a dependency relationship between device container(s) and device(s). Through association modeling of the measurement data and the grid model data, a topological association relationship among a device, a plant station and a main network is extracted, which provides a model basis for analyzing the power relationship among the plant station, a line and a transformer. Electrical relationship refers to electrical characteristics and a relationship between same.

In a power grid regulation system, generally, a measurement point is uniquely identified by an object ID code, a measurement type and a data source. In the process of regulating building of a cloud, the structured design of power dispatching general data objects models a data object relationship, data object ID coding, data object metadata definition and data dictionary, and describes a scheduling management relationship between dispatching organization(s) and device(s), an operation and maintenance management relationship between operation and maintenance organization(s) and device(s), and a dependency relationship between device container(s) and device(s). Through association modeling of measurement data and grid model data, a topological relationship among the device, the plant station and the main network is extracted, which provides a topological structure model foundation for measurement accuracy check.

The collection frequencies of measurement points sent by different regional power dispatching centers are different, and the sampling rules of the measurement points are shown in Table 1. The time-space relationship of the measurement data is analyzed according to a changing trend of a historical data curve, and different long-time scale power balance algorithm rules are formulated for the sampling frequencies of the measurement data in different regions.

TABLE 1
Collection frequency of measurement points

| Serial number | Frequency | Daily sampling points |
|---|---|---|
| 1 | 1 point/minute | 1440 |
| 2 | 5 points/minute | 288 |
| 3 | 15 point/minute | 96 |
| 4 | 60 points/minute | 24 |

At S30, active power deviation amount and deviation point of the plant station and the primary device are calculated by using a long-time scale power balance checking algorithm.

Here, the long-time scale power deviation amount and deviation point(s) are calculated by analyzing a power conservation relationship among a plant station, a line, a transformer and a current converter based on a connection relationship between a topological structure of the power grid and a plant station device, and performing statistics on minute-level measurement data reported by the plant station end.

Power balance is based on the power conservation relationship. Taking the plant station as an example, the deviation amount of inflow active power and outflow active power of all devices (main devices include a line, a transformer and a converter) in the same valid time section and the total power deviation amount of the set time scale are calculated. A deviation point refers to a time section where the power deviation in the set time scale is greater than a threshold value. Here, the whole method is described by taking the plant station as an example, but it is also applicable to calculating power balance check of the line and the transformer. The long-time scale power balance check of a line is judged by calculating the long-time scale power deviation amount according to the power conservation relationship between the head and the end of the line. The long-time scale power balance check of a transformer is judged by calculating the long-time scale power deviation amount according to the rate conservation relationship of each terminal of the transformer.

In the power system, a plant station generally includes a power plant, a transformer substation and a converter station. For the power plant and the transformer substation, the inflow active power and the outflow active power of devices such as all lines and transformers with the same voltage level in the station at the same time section are often considered, and the active power of a converter in the converter station will also affect the power balance thereof. The implementation steps of the long-time scale power balance check algorithm are as follows.

At S301, firstly, the device sequence of the same voltage level include devices Dvol={Vac,Vtf,Vct}, in which the line terminals of a line are Vac={Vac,1,Vac,2,Vac,n}, transformer windings are Vtf={Vtf,1,Vtf,2,Vtf,m}, and the inverters are Vct={Vct,1, Vct,2,Vct,k}.

Here, the devices in the plant station are grouped by voltage level according to the topological relationship among the device, the plant station and the main network.

At S302, non-null valid value time points of all the devices in Dvol are searched, and a valid time point sequence T={t1,t2, . . . ,tn} of power balance check of the plant station is calculated, and the number of valid points is the length of the valid time sequence T.

Here, the non-null valid value time points of all devices in Dvol are found out from the measurement data, and the valid time point sequence of the power balance check of all the devices in Dvol in the plant station is calculated.

At S303, deviations ΔP_{st,t}_{ᵢ} of the inflow active power and the outflow active power of all the devices in a device sequence of the plant station in the same valid time section are calculated. Herein, the calculation of the active power deviations ΔP_{st,t}_{ᵢ} includes that, firstly, the deviations of the inflow active power and the outflow active power of all the devices in the device sequence, including a line terminal of a line, a transformer winding and a current converter, in the same valid time section are calculated respectively, and then the active power deviations of all the devices are added to get ΔP_{st,t}_{ᵢ} as shown in formula (1):

ΔP_{st,t}_{ᵢ}=ΔP_{ac,t}_{ᵢ}+ΔP_{tf,t}_{ᵢ}+ΔP_{ct,t}_{ᵢ} (1)

where ΔP_{ac,t}_{ᵢ} indicates the deviation of the inflow active power and the outflow active power of a line terminal of a line at the valid time section ΔP_{tf,t}_{ᵢ} indicates the deviation of the inflow active power and the outflow active power of the transformer winding at the valid time section and ΔP_{ct,t}_{ᵢ} indicates the deviation of the inflow active power and the outflow active power of the current converter at the valid time section L.

At S304, the active power feature value of the power system is statistically extracted, and the power deviation threshold sequence τ={τ35,τ66, . . . ,τ220, . . . ,τ1000} of different voltage levels is set, where the subscript indicates the voltage level.

In some embodiments, power deviation threshold sequences of different voltage levels are set according to the active power feature value. During implementation, the active power feature value of the same voltage level as that in S301 is extracted and a corresponding power deviation threshold is set, which is marked as τᵥₒₗ.

At S305, the plant station power deviation ΔP_{st,t}_{ᵢ} in each valid time section is compared with the power deviation threshold of the corresponding voltage level.

In some embodiments, the deviation ΔP_{st,t}_{ᵢ} of the inflow active power and the outflow active power of the same valid time section obtained in S303 is compared with the power deviation threshold τᵥₒₗ of the corresponding voltage level. When ΔP_{st,t}_{ᵢ}<τᵥₒₗ, it is determined that there is no active power imbalance power problem in the section. When ΔP_{st,t}_{ᵢ}≥τᵥₒₗ, it is determined that there is an active power imbalance power problem in the section, and the time corresponding to the section is a power imbalance point.

During implementation, firstly, according to S302, the valid time point sequence of power balance check of all the devices in the device sequence of the plant station is obtained. Secondly, according to S303, the deviations of the inflow active power and outflow active power of all the devices in the device sequence of the plant station at the valid time section corresponding to each valid time point are calculated. Then, a power deviation threshold of the voltage level is set according to S304. Finally, the power deviation of the plant station in each valid time section is compared with the power deviation threshold of the corresponding voltage level to obtain an active power imbalance sequence corresponding to the valid time point sequence.

At S306, the active power imbalance sequence P′ₛₜ={(tₐ, ΔPₜ_{ₐ}, (t_{b}, ΔPₜ_{_{b}}), . . . ,(tᵣ, ΔPₜ_{ᵣ})} is recorded, where the number of power imbalance points is the length of the power imbalance sequence P′ₛₜ.

At S307, a total amount SUM_ΔP′ₛₜ of active power deviation and a deviation quantification index DVₛₜ of the plant station are calculated, where calculation of the total amount SUM_ΔP′ₛₜ of active power deviation is shown in formula (2) and calculation of the deviation quantification index DVₛₜ is shown in formula (3).

SUM_ΔP′ₛₜ=Σ_{I}^{N}ΔP_{st,t}_{ᵢ} (2)

where N represents the set time scale, and ΔP_{st,t}_{ᵢ} represents the deviation ΔP_{st,t}_{ᵢ} of the inflow active power and the outflow active power of each device in the same valid time section tᵢ.

DVₛₜ=len(P′ₛₜ)/len(T) (3)

where len(P′ₛₜ) represents the length of the power imbalance sequence P′ₛₜ, and len(T) represents the length of the valid time point sequence T.

In some embodiments, the ratio of power imbalance point is obtained from the deviation quantification index, which represents whether target measurement data has quality abnormality. Through the total amount of active power deviation, the total amount of power deviation in the set time scale may be obtained. By analyzing the total amount of active power deviation and the value of a target measurement data point, it can be analyzed what type of quality abnormality exists in the target measurement data.

For the power balance check of the primary device such as a line and a transformer, the deviation quantification index may be calculated based on the inflow and outflow active power of each terminal of the device in the same time section. Through the above method, different time scales are selected to calculate the deviation quantification index, so that not only the daily periodic change of the active power of the power system can be effectively reflected, but also the calculating speed and efficiency can be guaranteed. In the process of acquiring the measurement data of the measurement point, by comparing the measurement point information with the basic information model of the object in the structured design of a data object, the number of models of line terminal and transformer winding and the number of measurement points actually uploading data are analyzed, so as to quickly locate the data quality problems such as a model maintenance error, underreporting of data and missing of data.

At S40, a classification rule base of abnormal problems of measurement data is built to judge and classify abnormal results.

Here, according to the deviation quantification index calculated by using the long-time scale power balance checking algorithm, in conjunction with the actual situation of a power grid operation service, a cause for an abnormal data problem is analyzed, and a configurable and extensible classification rule base of abnormal problems of the measurement data is built, so that the abnormal data problems of power imbalance and causes thereof can be quickly judged.

In an actual power system, the data collected in the big data platform may have the problem of power imbalance due to situations such as a failure of the collection device, a collection error, a model maintenance error, and false data submission. The quality features of the measurement data are collected regularly. An accuracy check solution is provided for each type of quality problem, and a configurable and extensible classification rule of abnormal problems of measurement data is built, as shown in Table 2, so as to quickly judge the abnormal data problems of power imbalance and causes thereof, analyze the accuracy problems and features of long-period measurement data, and provide a diagnostic direction for predicting future data quality problems.

TABLE 2
Classification Rule for Abnormal Problems of Measurement Data

| Problem classification | Problem description |
|---|---|
| Mismatching of | Inconsistency of the number of device models |
| model with | that shall upload data with the number of devices |
| operation | that actually uploads data |
| Single-terminal | A situation where the measured value of active |
| measurement value | power at one terminal of the device has a constant |
| being 0 | value of 0 |
| Measured values | The measured values of active power at each |
| being in the same | terminal of the device being positive values or |
| direction | negative values at the same time |
| The measured value | No above three situations |
| being unreasonable | |

At S50, multi-dimensional dynamic interactive display and analysis is performed on a day-month-year curve and a daily accuracy check report of the measurement data.

Here, the accuracy analysis refers to the analysis of the power imbalance of the measurement data and a cause thereof, and rapid positioning and multi-dimensional dynamic interactive display are performed on the data quality problem through a big data visualization analysis method. Using the big data visualization analysis method and Massively Parallel Processing (MPP) database interaction technology, the data quality problem is subjected to rapid positioning and multi-dimensional dynamic interactive display, thus implementing multi-dimensional dynamic interactive display of a measurement accuracy check report and a year-month-day power curve of the measurement data. The distribution law of a long-period measurement data accuracy problem is analyzed, thus providing a direction for predicting the future data quality problem.

In some embodiments, the big data visualization analysis and MPP database interaction technology are adopted to implement the multi-dimensional dynamic interactive display of the measurement accuracy check report and the year-month-day curve of the measurement data.

In some embodiments, the data interaction specification is unified by adopting a big data platform, thus providing panoramic data service for measurement data across time and space, across business and across scheduling. Real-time display and eigenvalue analysis of the year-month-day curve of the measurement data and the superposition of multi-object curves are performed by calling the data service, and time-and-object-based comparison of historical measurement data curves from multiple scheduling interfaces and multiple data sources and export analysis of original data are supported. Regulation measurement data accuracy check supports “configurable, controllable and monitorable” rule configuration and threshold query. According to the visual display of real-time massive measurement data, a corresponding check strategy is formulated to improve the problem detection rate of hundreds of billions of measurement data and provide high-quality panoramic data support for deep mining of the power grid data value.

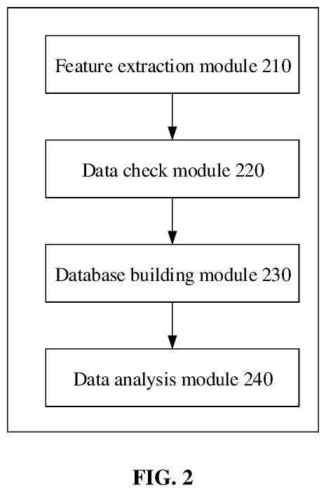

The embodiments of the present disclosure provide an apparatus for checking power grid measurement data. As shown in FIG. 2, the apparatus includes: a feature extraction module 210, a data check module 220, a database building module 230, and a data analysis module 240.

The feature extraction module 210 is configured to extract a feature factor of power grid measurement data.

The data check module 220 is configured to check power balance of a set time scale based on the measurement data and the feature factor, to obtain a check result.

The database building module 230 is configured to build a classification rule base of abnormal problems of measurement data based on the check result.

The data analysis module 240 is configured to check an abnormal problem in target measurement data based on the classification rule base of abnormal problems of measurement data, to obtain a measurement data quality report.

In some embodiments, the apparatus further includes: a data acquisition module, configured to acquire power grid measurement data, model data and dictionary data; and a data association module, configured to associate the measurement data, the model data and the dictionary data in different dimensions to obtain a measurement check data set. Herein, the different dimensions include at least two of the following: a power device object, a data source and time.

In some embodiments, the apparatus further includes: a first loading module, configured to connect each newly added measurement data according to a service timestamp and load the newly added measurement data into a first memory; and a second loading module, configured to load the newly added model data and dictionary data into a second memory.

In some embodiments, the feature extraction module is configured to extract a feature factor of the measurement data based on the model data and the measurement data.

In some embodiments, the feature factor includes a time-space relationship and a topological structure. The data check module is configured to acquire a sampling frequency of the measurement data; determine a power balance check algorithm based on the sampling frequency and the time-space relationship; and check power balance of the set time scale based on the topological structure, the measurement data and the power balance check algorithm, to obtain a check result.

In some embodiments, the data check module is configured to: group devices by voltage level according to the topological structure, to obtain a device sequence of a same voltage level; search non-null valid value time points of all the devices in the device sequence from the measurement data, and determine a valid time point sequence of the power balance check of all the devices in the device sequence, the number of valid points in the valid time point sequence being the length of the valid time point sequence; determine an active power imbalance point and an active power imbalance sequence of the set time scale based on the device sequence, the valid time point sequence and the power balance check algorithm, the number of the active power unbalance points being the length of the active power unbalance sequence; determine the total amount of active power deviation of the set time scale based on the active power imbalance sequence; determine a deviation quantification index of the set time scale based on the length of the active power imbalance sequence and the length of the valid time point sequence; and obtain a check result according to the total amount of active power deviation and the deviation quantification index of the set time scale.

In some embodiments, the data check module is configured to: determine deviations of inflow active power and outflow active power of all the devices in the device sequence in the same valid time section; extract an active power feature value of a voltage level corresponding to the device sequence in a power system; determine a power deviation threshold of a voltage level corresponding to the device sequence based on the active power feature value; and compare the active power deviation with the power deviation threshold to obtain the active power imbalance point and the active power imbalance sequence of the set time scale.

In some embodiments, the data check module is configured to: determine that no active power imbalance points exist in the valid time section when the active power deviation is less than the power deviation threshold; determine the time corresponding to the valid time section as the active power imbalance point when the active power deviation is greater than or equal to the power deviation threshold; and record the active power imbalance points of a plurality of valid time sections of the set time scale to obtain the active power imbalance sequence.

In some embodiments, the database building module is configured to: build the classification rule base of abnormal problems of measurement data based on the check result and an actual situation of a power grid operation service.

In some embodiments, the apparatus further includes: a visual display module, configured to perform multi-dimensional dynamic interactive display and analysis on the measurement data quality report.

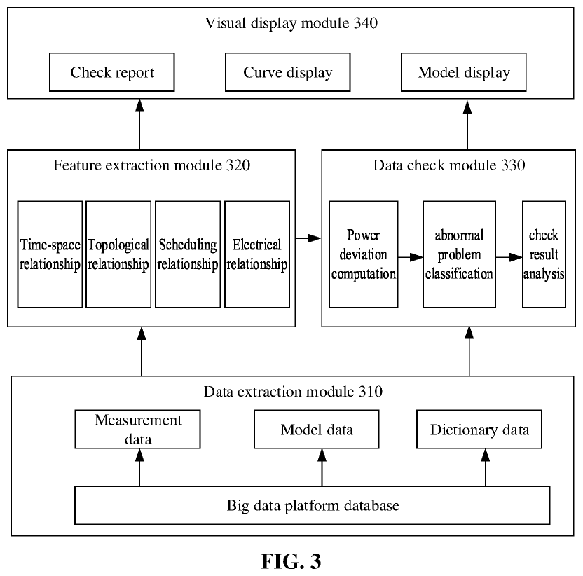

The embodiments of the present disclosure provide a frame diagram of an apparatus for checking power grid measurement data. As shown in FIG. 3, the apparatus includes: a data extraction module 310, a feature extraction module 320, a data check module 330, and a visual display module 340.

The data extraction module 310 is configured to extract massive measurement data, model data and dictionary data from a Hbase column database and a data warehouse at a big data platform through a Spark distributed calculating engine, and provide data support for other modules of the system.

The feature extraction module 320 is configured to analyze long-period massive power grid regulation measurement data, and extract a feature factor such as a time-space relationship, a topological structure and an electrical relationship of the measurement data based on the power grid model data.

The data check module 330 is configured to calculate long-time scale power deviation and classify and analyze abnormal results.

The visual display module 340 is configured to perform multi-dimensional dynamic interactive display and analysis on the accuracy result of the measurement data, including query and export of a data check report, real-time display and eigenvalue analysis of a day-month-year curve of the measurement data and superposition of multi-object curves, and query of model information.

The embodiments of the present disclosure further provide a computer device. The device includes: a processor, a memory and a computer program stored in the memory and running on the processor, such as a long-time scale power balance check program. When executing the computer program, the processor implements the steps in the above method embodiments. Or, when executing the computer program, the processor implements the functions of each module/unit in the above apparatus embodiments. For example, the data check module is configured to calculate a power deviation of a set time scale, and classify and analyze abnormal results.

The computer program may be divided into one or more modules/units, and the one or more modules/units are stored in the memory and executed by the processor to complete the present disclosure.

The processor may also be a Central Processing Unit (CPU), or another general-purpose processor, a Digital Signal Processor (DSP), an Application Specific Integrated Circuit (ASIC), a Field Gate Array (FPGA) or other programmable logic devices, a discrete gate or transistor logic device, or a discrete hardware component.

The memory may be configured to store the computer program and/or module, and the processor implements various functions of a long-time scale power balance check and big data analysis apparatus by running or executing the computer program and/or module stored in the memory and calling the data stored in the memory.

The integrated module/unit of the long-time scale power balance check and big data analysis apparatus may be stored in a computer-readable storage medium if being implemented in the form of a software functional unit and sold or used as an independent product. Based on such an understanding, all or part of the processes in the embodiment method are implemented in the present disclosure, which may also be completed by instructing related hardware through a computer program. The computer program may be stored in a computer-readable storage medium, and when executed by a processor, the computer program may implement the steps of the above method embodiments. Herein, the computer program includes a computer program code, and the computer program code may be in the form of source code, object code, executable file or some intermediate form. The computer readable medium may include: any entity or apparatus capable of carrying the computer program code, a recording medium, a U disk, a removable hard disk, a magnetic disk, an optical disk, a computer memory, a Read Only Memory (ROM), a Random Access Memory (RAM), an electrical carrier signal, a telecommunication signal, a software distribution medium, etc. It is to be noted that the contents contained in the computer-readable medium may be appropriately increased or decreased according to the requirements of legislation and patent practice in jurisdictions. For example, in some jurisdictions, according to legislation and patent practice, the computer-readable medium does not include the electrical carrier signal and the telecommunication signal.

The above is only the preferred embodiments of the present disclosure and is not used to limit the present disclosure. For those skilled in the art, there may be various changes and variations in the present disclosure. Any modifications, equivalent replacements, improvements and the like made within the spirit and principle of the present disclosure shall fall within the scope of protection of the present disclosure.

### INDUSTRIAL PRACTICABILITY

In the embodiments of the present disclosure, the method for checking power grid measurement data includes that a feature factor of the power grid measurement data is extracted; power balance of a set time scale is checked based on the measurement data and the feature factor to obtain a check result; and a classification rule base of abnormal problems of measurement data is built based on the check result. An abnormal problem in target measurement data is checked based on the classification rule base of abnormal problems of measurement data to obtain a measurement data quality report. In the present disclosure, power balance of a set time scale is checked based on measurement data and a feature factor to obtain a check result; a classification rule base of abnormal problems of measurement data is built based on the check result; and an abnormal problem in target measurement data is checked based on the classification rule base of abnormal problems of measurement data, to generate a measurement data quality report. Thus, the embodiments of the present disclosure can quickly decide the problems and causes of the abnormality of the measurement data, improve the data analysis ability, and provide technical support for lean management of deep mining and regulation of data value of the large power grid.

1. A method for checking power grid measurement data, comprising:
extracting a feature factor of the power grid measurement data;
checking power balance of a set time scale based on the measurement data and the feature factor, to obtain a check result;
building a classification rule base of abnormal problems of measurement data based on the check result; and
checking, based on the classification rule base of abnormal problems of measurement data, an abnormal problem in target measurement data, to obtain a measurement data quality report.

2. The method of claim 1, further comprising:
acquiring power grid measurement data, model data and dictionary data; and
associating the measurement data, the model data and the dictionary data in different dimensions to obtain a measurement check data set, wherein the different dimensions comprise at least two of the following: a power device object, a data source and time.

3. The method of claim 2, further comprising:
connecting each newly added measurement data according to a service timestamp and load the newly added measurement data into a first memory; and
loading the newly added model data and dictionary data into a second memory.

4. The method of claim 2, wherein extracting a feature factor of the power grid measurement data comprises:
extracting a feature factor of the measurement data based on the model data and the measurement check data set.

5. The method of claim 1, wherein the feature factor comprises a time-space relationship, a topological structure and an electrical relationship, wherein checking power balance of a set time scale based on the measurement data and the feature factor to obtain a check result comprises:
acquiring a sampling frequency of the measurement data;
determining a power balance check algorithm based on the sampling frequency, the time-space relationship, and the electrical relationship; and
checking power balance of the set time scale based on the topological structure, the measurement data and the power balance check algorithm, to obtain a check result.

6. The method of claim 5, wherein checking power balance of the set time scale based on the topological structure, the measurement data and the power balance check algorithm, to obtain a check result, comprises:
grouping devices by voltage level according to the topological structure, to obtain a device sequence of a same voltage level;
searching non-null valid value time points of all the devices in the device sequence from the measurement data, and determining a valid time point sequence of the power balance check of all the devices in the device sequence, wherein a number of valid points in the valid time point sequence is a length of the valid time point sequence;
determining active power imbalance points and an active power imbalance sequence of the set time scale based on the device sequence, the valid time point sequence and the power balance check algorithm, wherein a number of the active power imbalance points is a length of the active power unbalance sequence;
determining, based on the active power imbalance sequence, a total amount of active power deviation of the set time scale;
determining a deviation quantification index of the set time scale based on the length of the active power imbalance sequence and the length of the valid time point sequence; and
obtaining a check result according to the total amount of active power deviation and the deviation quantification index of the set time scale.

7. The method of claim 6, wherein determining active power imbalance points and an active power imbalance sequence of the set time scale based on the device sequence, the valid time point sequence and the power balance check algorithm comprises:
determining deviations of inflow active power and outflow active power of all the devices in the device sequence in a same valid time section;
extracting an active power feature value of a voltage level corresponding to the device sequence in a power system;
determining a power deviation threshold of a voltage level corresponding to the device sequence based on the active power feature value; and
comparing the active power deviation with the power deviation threshold to obtain the active power imbalance points and the active power imbalance sequence of the set time scale.

8. The method of claim 7, wherein comparing the active power deviation with the power deviation threshold to obtain the active power imbalance points and the active power imbalance sequence of the set time scale comprises:
determining that no active power imbalance points exist in the valid time section when the active power deviation is less than the power deviation threshold;
determining time corresponding to the valid time section as an active power imbalance point, when the active power deviation is greater than or equal to the power deviation threshold; and
recording the active power imbalance points of a plurality of valid time sections of the set time scale to obtain the active power imbalance sequence.

9. The method of claim 6, wherein building a classification rule base of abnormal problems of measurement data based on the check result comprises:
building the classification rule base of abnormal problems of measurement data based on the check result and an actual situation of a power grid operation service.

10. The method of claim 1, further comprising:
performing multi-dimensional dynamic interactive display and analysis on the measurement data quality report.

11. A computer device, comprising a memory, a processor and a computer program which is stored on the memory and may run on the processor, wherein when executing the computer program, the processor is configured to:
extract a feature factor of power grid measurement data;
check power balance of a set time scale based on the measurement data and the feature factor, to obtain a check result;
build a classification rule base of abnormal problems of measurement data based on the check result; and
check, based on the classification rule base of abnormal problems of measurement data, an abnormal problem in target measurement data, to obtain a measurement data quality report.

12. The computer device of claim 11, wherein the processor is further configured to:
acquire power grid measurement data, model data and dictionary data; and
associate the measurement data, the model data and the dictionary data in different dimensions to obtain a measurement check data set, wherein the different dimensions comprise at least two of the following: a power device object, a data source and time.

13. The computer device of claim 12, wherein the processor is further configured to:
connect each newly added measurement data according to a service timestamp and load the newly added measurement data into a first memory; and
load the newly added model data and dictionary data into a second memory.

14. The computer device of claim 12, wherein in extracting the feature factor of power grid measurement data, the processor is configured to:
extract, based on the model data and the measurement data, a feature factor of the measurement data.

15. The computer device of claim 11, wherein the feature factor comprises a time-space relationship and a topological structure, wherein in checking the power balance of the set time scale, the processor is configured to:
acquire a sampling frequency of the measurement data;
determine a power balance check algorithm based on the sampling frequency and the time-space relationship; and
check power balance of the set time scale based on the topological structure, the measurement data and the power balance check algorithm, to obtain a check result.

16. The computer device of claim 15, wherein in checking the power balance of the set time scale, the processor is configured to:
group devices by a voltage level according to the topological structure to obtain a device sequence of a same voltage level;
search non-null valid value time points of all the devices in the device sequence from the measurement data, and determine a valid time point sequence of the power balance check of all the devices in the device sequence, wherein a number of valid points in the valid time point sequence is a length of the valid time point sequence;
determine active power imbalance points and an active power imbalance sequence of the set time scale, based on the device sequence, the valid time point sequence and the power balance check algorithm, wherein a number of the active power imbalance points is a length of the active power unbalance sequence;
determine, based on the active power imbalance sequence, a total amount of active power deviation of the set time scale;
determine a deviation quantification index of the set time scale based on the length of the active power imbalance sequence and the length of the valid time point sequence; and
obtain a check result according to the total amount of active power deviation and the deviation quantification index of the set time scale.

17. The computer device of claim 16, wherein in checking the power balance of the set time scale, the processor is configured to:
determine deviations of inflow active power and outflow active power of all the devices in the device sequence in a same valid time section;
extract an active power feature value of a voltage level corresponding to the device sequence in a power system;
determine a power deviation threshold of a voltage level corresponding to the device sequence based on the active power feature value; and
compare the active power deviation with the power deviation threshold to obtain the active power imbalance points and the active power imbalance sequence of the set time scale.

18. The computer device of claim 17, wherein in checking the power balance of the set time scale, the processor is configured to:
determine that no active power imbalance points exist in the valid time section when the active power deviation is less than the power deviation threshold;
determine time corresponding to the valid time section as an active power imbalance point, when the active power deviation is greater than or equal to the power deviation threshold; and
record the active power imbalance points of a plurality of valid time sections of the set time scale to obtain the active power imbalance sequence.

19. The computer device of claim 16, wherein in building the classification rule base of abnormal problems of measurement data, the processor is configured to:
build the classification rule base of abnormal problems of measurement data based on the check result and an actual situation of a power grid operation service.

20. The computer device of claim 11, wherein the processor is further configured to:
perform multi-dimensional dynamic interactive display and analysis on the measurement data quality report.

21.-23. (canceled)
